(19) United States
(12) Patent Application Publication
(10) Pub. No.: US 2020/0130062 A1
(43) Pub. Date: Apr. 30, 2020

(54) METHOD FOR MANUFATURING OF POLYCRYSTALLINE SUPERHARD CUTTER UTILIZING INTERNAL FRAME

(71) Applicant: VAREL INTERNATIONAL IND., L.L.C., CARROLLTON, TX (US)

(72) Inventor: FEDERICO BELLIN, TOMBALL, TX (US)

(21) Appl. No.: 16/547,808

(22) Filed: Aug. 22, 2019

Related U.S. Application Data
(60) Provisional application No. 62/753,364, filed on Oct. 31, 2018.

(51) Int. Cl. B22F 7/08; B23B 27/14; B33Y 80/00; B22F 3/14; B22F 5/00; B22F 3/24

(52) U.S. Cl. CPC B22F 7/08; B23B 27/148; B33Y 80/00; B22F 3/14; B22F 2302/406; B22F 3/24; B23B 2228/00; B22F 2005/001; B22F 2003/244; B22F 5/00

(57) ABSTRACT

A method for manufacturing a cutter includes: placing a can into a press, the can comprising superhard powder, a metallic frame embedded in the superhard powder, and catalyst; operating the press to sinter the superhard powder, thereby forming a polycrystalline superhard cutting head; and exposing at least a portion of the polycrystalline superhard cutting head and the frame to acid for removing at least a portion of the catalyst from the polycrystalline superhard cutting head. The leaching frame comprises a plurality of branches. Each branch has an inner end located adjacent to a front face of the cutting head and an outer end located adjacent to a side of the cutting head. The acid tunnels into the polycrystalline superhard cutting head by dissolving the leaching frame.

### BACKGROUND OF THE DISCLOSURE

### Field of the Disclosure

The present disclosure generally relates to a method for manufacturing of a polycrystalline superhard cutter utilizing an internal frame.

### Description of the Related Art

U.S. Pat. No. 8,997,897 discloses depositing a layer of matrix powder within a mold opening. A layer of super-abrasive particles is then deposited over the matrix powder layer. The super-abrasive particles have a non-random distribution, such as being positioned at locations set by a regular and repeating distribution pattern. A layer of matrix powder is then deposited over the super-abrasive particles. The particle and matrix powder layer deposition process steps are repeated to produce a cell having alternating layers of matrix powder and non-randomly distributed super-abrasive particles. The cell is then fused, for example using an infiltration, hot isostatic pressing or sintering process, to produce an impregnated structure. A working surface of the impregnated structure that is oriented non-parallel (and, in particular, perpendicular) to the super-abrasive particle layers is used as an abrading surface for a tool.

U.S. Pat. No. 9,302,945 discloses a method including depositing alternating layers of a ceramic powder and a pre-ceramic polymer dissolved in a solvent. Each layer of the pre-ceramic polymer is deposited in a shape corresponding to a cross section of an object. The alternating layers of the ceramic powder and the pre-ceramic polymer are deposited until the layers of the pre-ceramic polymer form the shape of the object. The method includes heating the deposited ceramic powder and pre-ceramic polymer to at least a decomposition temperature of the pre-ceramic polymer. The decomposition temperature of the pre-ceramic polymer is less than a sintering temperature of the ceramic powder. The method further includes removing excess ceramic powder that the pre-ceramic polymer was not deposited onto.

U.S. Pat. No. 9,393,674 discloses a carbide composite for a downhole tool formed by depositing a first layer on a substrate, and a second layer at least partially adjacent to the first layer. The first and second layers may each include carbides, metal binders, organic binders, or a combination thereof. The first and second carbide layers may have a different particle size, particle shape, carbide concentration, metal binder concentration, or organic binder concentration from one another.

US 2014/0069726 discloses varying the rate of leaching of a polycrystalline diamond (PCD) cutting layer for cutting elements or other wear parts by introduction into the PCD of an additive prior to leaching. Selective introduction of the additive into one or more regions of a PCD cutting structure allows controlling leaching rates of selective leaching of parts of the PCD structure, which allows for creating of a boundary between the leached and non-leached regions of a PCD structure to be made so that is not parallel to the surface or surfaces exposed to the leaching solution. The additive is comprised of a material that increases the permeability of the PCD or acceptance of the PCD to the leaching solution, such as a hydrophile.

US 2018/0250647 discloses a lithography based method for the manufacture of diamond composite materials in which green bodies are prepared by a layer-by-layer construction with resulting green bodies de-bound and sintered to achieve a dense high hardness material.

US 2018/0313163 discloses a cutting table including hard material, and a fluid flow pathway within the hard material. The fluid flow pathway is configured to direct fluid proximate outermost boundaries of the hard material through one or more regions of the hard material inward of the outermost boundary of the hard material. A cutting element and an earth-boring tool are also described.

WO 2018/050796 discloses a method for manufacturing an impregnated segment includes forming a base tier by depositing one or more layers of molten metallic material. The base tier has a plurality of cavities. The method further includes inserting at least one superhard particle into each cavity and forming an additional tier on top of the base tier by depositing one or more layers of the molten metallic material. The additional tier has a plurality of cavities. The method further includes repeating the insertion of the superhard particles and the formation of additional tiers to form an impregnated cage.

WO 2018/084839 discloses a sintering assembly and a polycrystalline diamond compact (PDC) including an acid-labile leach-enhancing material, a PDC including cavities formed by removal of an acid-labile leach-enhancing material, and a method of forming a leached PDC using an acid-labile leach-enhancing material. The present disclosure further includes drill bits using PDCs formed suing an acid-labile leach-enhancing material.

### SUMMARY OF THE DISCLOSURE

The present disclosure generally relates to a method for manufacturing of a polycrystalline superhard cutter utilizing an internal frame. In one embodiment, a method for manufacturing a cutter includes: placing a can into a press, the can comprising superhard powder, a metallic frame embedded in the superhard powder, and catalyst; operating the press to sinter the superhard powder, thereby forming a polycrystalline superhard cutting head; and exposing at least a portion of the polycrystalline superhard cutting head and the frame to acid for removing at least a portion of the catalyst from the polycrystalline superhard cutting head. The leaching frame comprises a plurality of branches. Each branch has an inner end located adjacent to a front face of the cutting head and an outer end located adjacent to a side of the cutting head. The acid tunnels into the polycrystalline superhard cutting head by dissolving the leaching frame.

In another embodiment, a method for manufacturing a cutter includes: forming a leaching frame; applying catalyst to the leaching frame, thereby forming a composite frame; placing a can into a press, the can comprising superhard powder and the composite frame embedded in the superhard powder; operating the press to sinter the superhard powder, thereby forming polycrystalline superhard cutting head, wherein the catalyst portion of the frame melts and disperses within the superhard powder; and exposing at least a portion of the polycrystalline superhard cutting head and the remaining leaching frame to acid for removing at least a portion of the catalyst from the polycrystalline superhard cutting head. The acid tunnels into the polycrystalline superhard cutting head by dissolving the remaining leaching frame

In another embodiment, a method for manufacturing a cutter includes: placing a can into a press, the can comprising superhard powder and a catalyst frame embedded in the superhard powder; and operating the press to sinter the superhard powder, thereby forming a polycrystalline superhard cutting head.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates additive manufacturing of a leaching frame, according to one embodiment of the present disclosure.

FIGS. 2A and 2B illustrate the manufactured leaching frame.

FIG. 3A illustrates the leaching frame loaded into an inner can for a high pressure and high temperature (HPHT) sintering operation. FIG. 3B illustrates cutting table powder loaded into the inner can. FIG. 3C illustrates a substrate loaded into the inner can and placement of an outer can.

FIG. 4 illustrates the HPHT sintering operation to form a superhard cutter.

FIG. 5A illustrates grinding of the superhard cutter. FIG. 5B illustrates the cutting table of the superhard cutter.

FIGS. 6A and 6B illustrate leaching of the cutting table.

FIG. 7 illustrates brazing of the leached cutter into a blade of a drill bit.

FIG. 8A illustrates additive manufacturing of a second leaching frame, according to another embodiment of the present disclosure. FIG. 8B illustrates the manufactured second frame.

FIG. 9A illustrates the second leaching frame loaded into the inner can for the high pressure and high temperature (HPHT) sintering operation. FIG. 9B illustrates cutting table powder loaded into the inner can. FIG. 9C illustrates the substrate loaded into the inner can and placement of the outer can.

FIG. 10A illustrates the sintered cutting table of a second superhard cutter.

FIG. 10B illustrates leaching of the second cutting table.

FIG. 11 illustrates additive manufacturing of a catalyst frame, according to one embodiment of the present disclosure.

FIGS. 12A and 12B illustrate the manufactured catalyst frame.

FIG. 13A illustrates the catalyst frame loaded into the inner can for the high pressure and high temperature (HPHT) sintering operation. FIG. 13B illustrates cutting table powder loaded into the inner can. FIG. 13C illustrates intermediate powder loaded into the inner can. FIG. 13D illustrates a second substrate loaded into the inner can and placement of the outer can.

FIG. 14A illustrates additive manufacturing of a composite leaching and catalyst frame, according to another embodiment of the present disclosure. FIG. 14B illustrates a leg of the composite frame. FIG. 14C illustrates additive manufacturing of a green cutting table.

FIG. 15 illustrates de-binding of the green cutting table to form a brown cutting table.

FIG. 16A illustrates the brown cutting table loaded into the inner can for the high pressure and high temperature (HPHT) sintering operation. FIG. 16B illustrates the intermediate powder loaded into the inner can. FIG. 16C illustrates the second substrate loaded into the inner can and placement of the outer can.

FIGS. 17A and 17B illustrate a shaped cutter having a second catalyst frame, according to another embodiment of the present invention.

### DETAILED DESCRIPTION

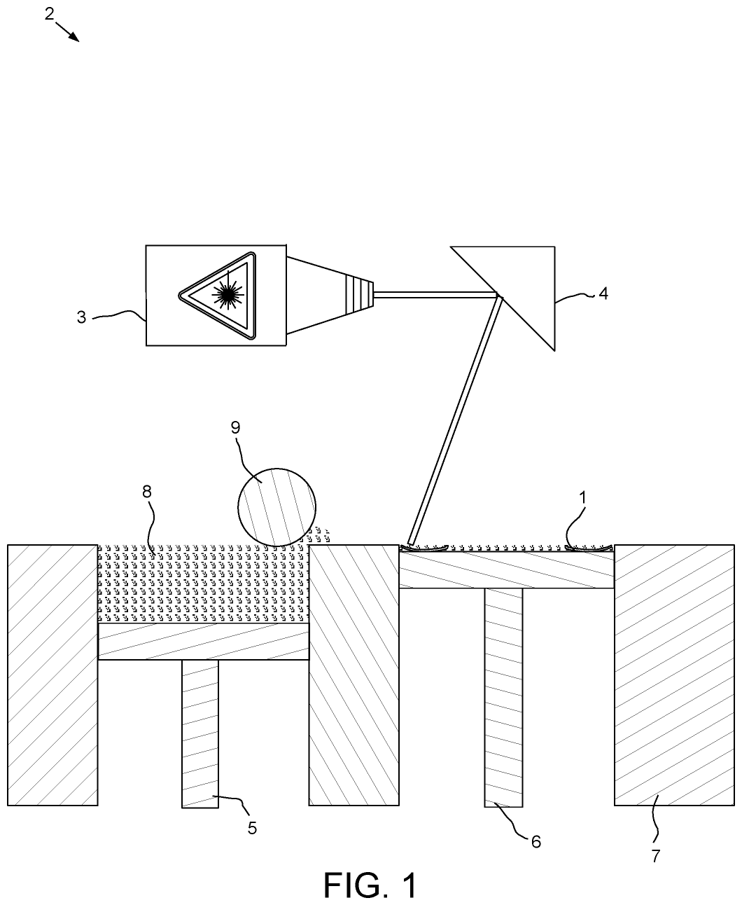

FIG. 1 illustrates additive manufacturing of a leaching frame 1, according to one embodiment of the present disclosure. The leaching frame 1 may be formed using a 3d printer 2. The 3d printer 2 may include a laser 3, a scanner 4, a feed piston 5, a part piston 6, a housing 7, a supply of frame powder 8, and a roller 9. The 3d printer 2 may further include a controller (not shown), such as a microcontroller or programmable logic controller, having a CAM model of the leaching frame 1 loaded into memory thereof. The scanner 4 may further include a deflector in visual communication with the laser 3 and an actuator for moving the deflector for scanning the laser along a path corresponding to a slice of the leaching frame 1. The controller may be in communication with the scanner actuator and an actuator of each piston 5, 6. The laser 3 may supply a sufficiently intense beam to sinter or melt the frame powder 8. The part piston 6 may be lowered by the controller by an increment corresponding to a thickness of the slice once the slice has been completed by the scanner 4 and laser 3. The supply piston 5 may be raised to ensure that the roller 9 is supplied with the frame powder 8 and the roller may distribute the frame powder therefrom to the part piston 6 after each slice of the leaching frame 1 has been completed.

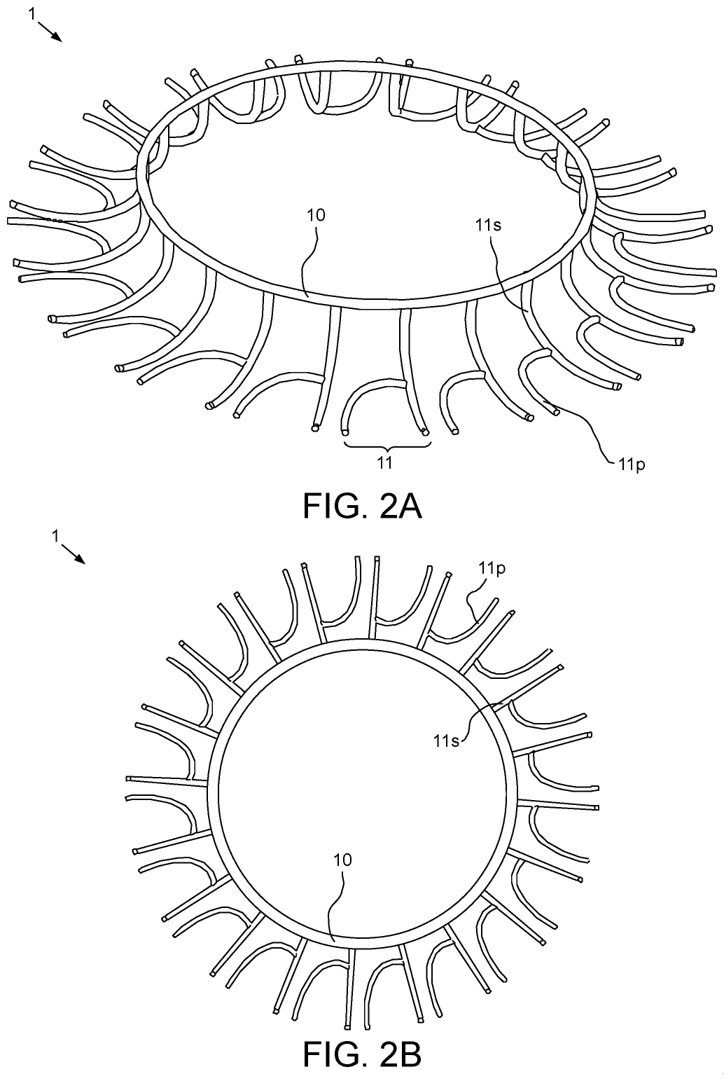

FIGS. 2A and 2B illustrate the manufactured leaching frame 1. The leaching frame 1 may include a base ring 10 and a plurality of branches 11 extending outward therefrom. The branches 11 may be spaced around the base ring 10 at regular intervals, such as three-hundred sixty degrees divided by the number of branches. The base ring 10 may have a circular cross-section and each branch 11 may be cylindrical. Each branch 11 may have a shank 11s and a prong 11p. The shank 11s may have vertical portion extending from the base ring, a slightly curved radial portion, and an elbow connecting the vertical and radial portions. The prong 11p may have a circumferential portion extending from the radial portion of the shank 11s, a radial tip, and an elbow portion connecting circumferential portion and the tip.

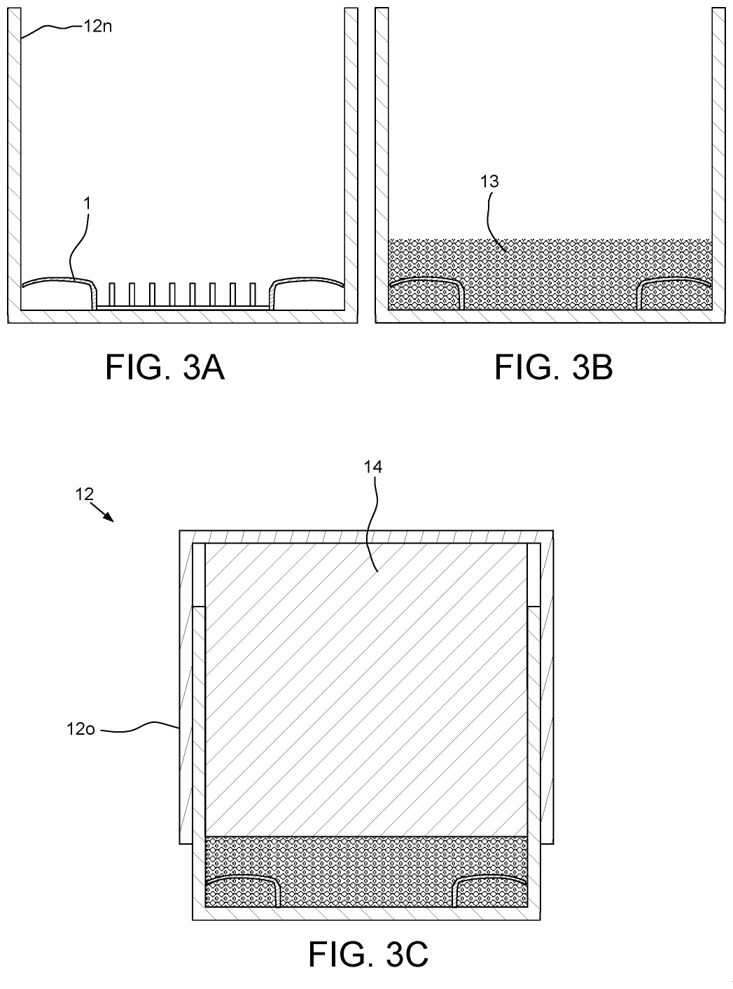

FIG. 3A illustrates the leaching frame 1 loaded into an inner can 12n for a high pressure and high temperature (HPHT) sintering operation. The inner can 12n may be made from a refractory metal and may have a cylindrical cavity formed therein for receiving the leaching frame 1. The leaching frame 1 may be loaded into the inner can 12n so that the base ring 10 rests on a bottom thereof.

FIG. 3B illustrates cutting table powder 13 loaded into the inner can 12n. The cutting table powder 13 may be monocrystalline synthetic diamond. A quantity of the cutting table powder 13 may be poured into the inner can 12n. During or after pouring of the cutting table powder 13, the inner can 12n may be vibrated to compact the cutting table powder. The quantity of cutting table powder 13 may be sufficient to form a layer in the inner can 12n having a thickness sufficient to embed the leaching frame 1 therein.

Alternatively, the cutting table powder 13 may be another superhard material powder, such as cubic boron nitride powder, instead of the diamond powder.

FIG. 3C illustrates a substrate 14 loaded into the inner can 12n and placement of an outer can 12o. The substrate 14 may be cylindrical and pre-fabricated by a sintering operation, such as hot isotactic pressing. The substrate 14 may be fabricated from a hard material, such as a cermet. The cermet may be a cemented carbide, such as a group 8-10 metal-tungsten carbide. The group 8-10 metal may be cobalt. The substrate 14 may be inserted into the cavity of the inner can 12n and into engagement with the cutting table powder 13 while a back portion of the substrate may protrude from an end of the inner can 12n. The outer can 12o may then placed over the inner can 12n. The outer can 12o may be made from a refractory metal and may have a cylindrical cavity formed therein for receiving the inner can 12n and the back portion of the substrate 14. The loaded cans 12n,o may then be sealed, thereby forming a can assembly 12.

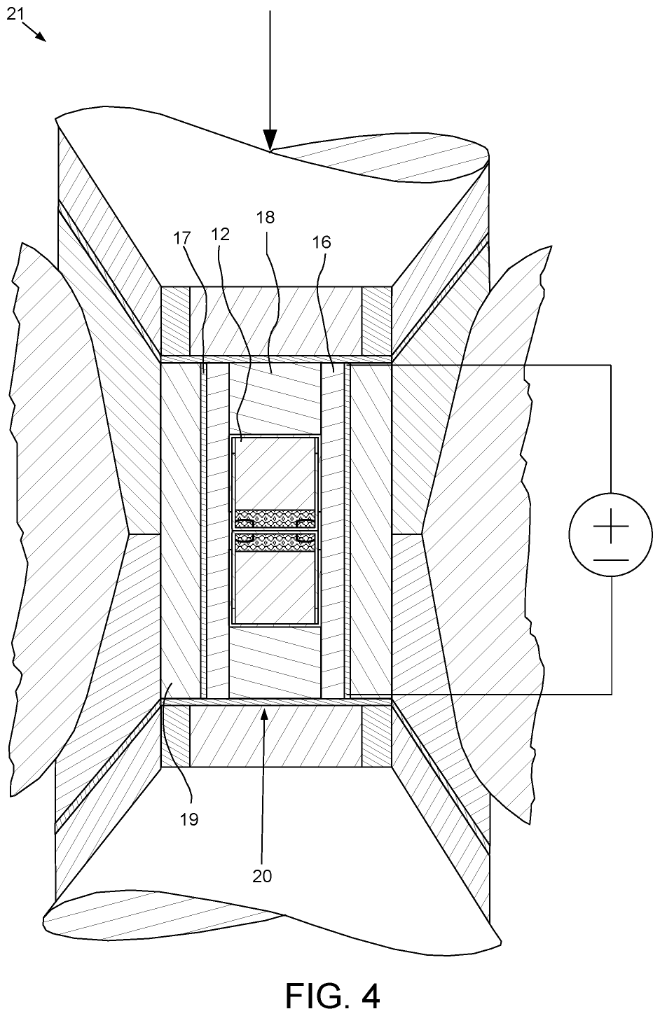

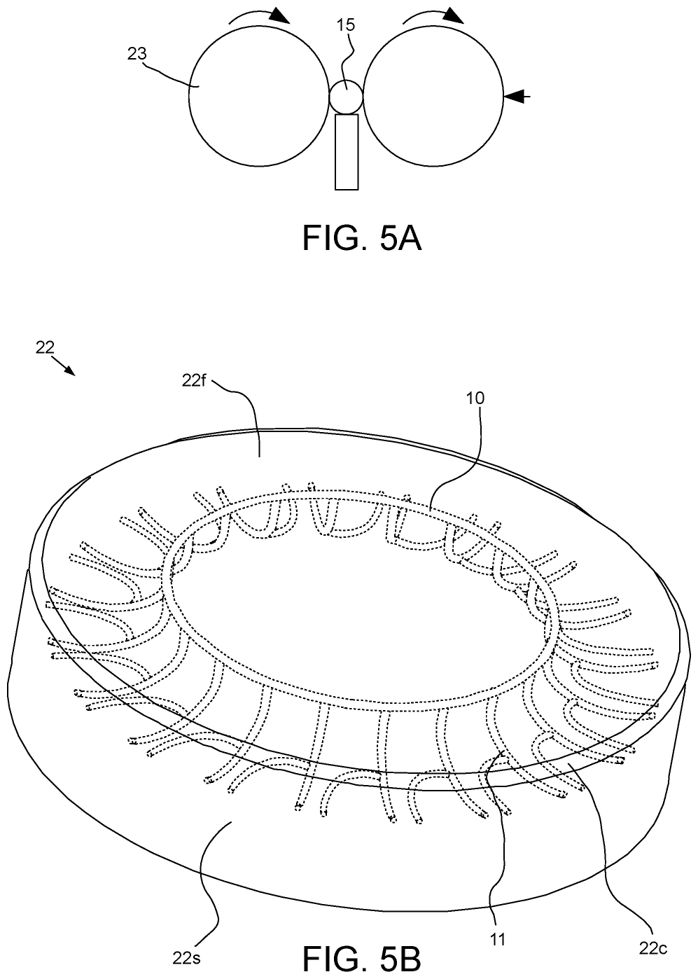

FIG. 4 illustrates the HPHT sintering operation to form a superhard cutter 15 (FIG. 5A). A plurality of can assemblies 12 may be assembled with a liner 16, a heating element 17, a pair of plugs 18, and a cylinder 19 to form a cell 20. The cell 20 may then be inserted into a HPHT press, such as a belt press 21, and the belt press operated to perform the HPHT sintering operation, thereby causing the metal component of the substrate 14 to melt and sweep into the cutting table powder 13. The molten metal may act as a catalyst for recrystallization of the superhard monocrystalline diamond into polycrystalline diamond (PCD), thereby forming a coherent cutting table 22 (FIG. 5B), while bonding the cutting table and substrate 14 together to form the superhard cutter 15. A temperature of the HPHT sintering operation may range between fourteen hundred and eighteen hundred degrees Celsius and a pressure thereof may range between four and ten gigaPascals.

In order to prevent mangling of the leaching frame 1 during the HPHT sintering operation, the frame powder 8 may be metallic, such as a metal or metal carbide, having a melting temperature greater than the HPHT sintering temperature, discussed above. The frame powder 8 may also be susceptible to acid attack.

Alternatively, a cubic press may be used to perform the HPHT sintering operation instead of the belt press 21. Alternatively, the inner can 12n may have a nonplanar bottom for forming a shaped cutting head instead of the planar cutting head, such as the cutting table 22.

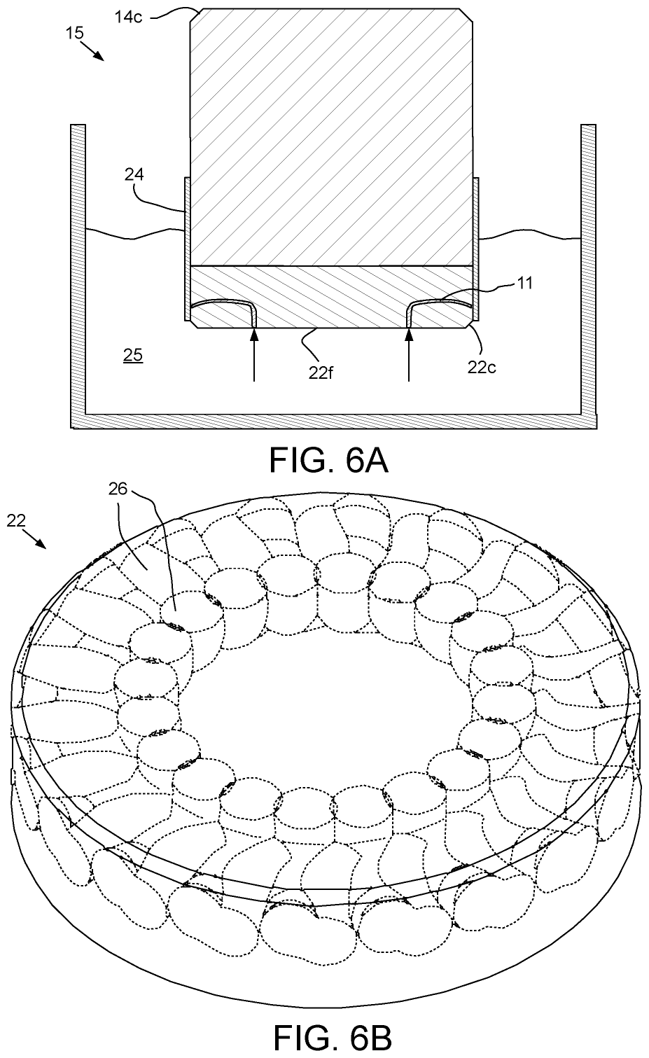

FIG. 5A illustrates grinding of the superhard cutter 15. The cutter 15 may be removed from the cell 20 and inserted into a cylindrical grinder 23 and/or other finishing machines to remove excess material, polish surfaces thereof, and form a chamfer 22c (FIG. 5B) into a periphery of the cutting table 22 at a front face 22f (FIG. 5B) thereof distal from the substrate 14 and a chamfer 14c (FIG. 6A) into a periphery of the substrate 14 at the back end thereof.

FIG. 5B illustrates the cutting table 22 of the superhard cutter 15. The base ring 10 may have an outer diameter ranging between forty percent and eighty percent of a diameter of the cutting table 22 and may be located at the front face 22f of the cutting table 22. The branches 11 may have inner ends connected to the base ring 10 and may extend backward and outward from the base ring such that outer ends thereof are located adjacent to a side 22s of the cutting table and behind the chamfer 22c. The distal ends of the branches 11 may be slightly sub-flush with the side 22s of the cutting table 22.

Alternatively, the distal ends of the branches 11 may be flush with the periphery of the cutting table 22.

FIGS. 6A and 6B illustrate leaching of the cutting table 22. A portion of the substrate 14 and a side 22s of the cutting table may be masked 24. At least a front portion of the cutting table 22 may then be submerged into a bath of acid 25, such as Aqua regia, a mixture of nitric acid and hydrofluoric acid, nitric acid, and hydrofluoric acid, and left therein for a soaking time. The acid 25 may dissolve the leaching frame 1, thereby forming leaching tunnels into the cutting table 22 around the base ring 10 and along the branches 11. Facilitated by the leaching tunnels, the acid 25 may leach at least a substantial portion of the catalyst from a portion of the cutting table 22 adjacent to the front face 22f and side 22s thereof. FIG. 6B specifically illustrates leached regions 26 of the cutting table 22 attributable to the leaching tunnels. For clarity, the leached regions attributable to the acid 25 migrating through the non-framed regions of the cutting table 22 are not shown. The acid 25 will also migrate through interstitial spaces in the cutting table to create additional leached regions which will merge with the leached regions 26 attributable to the leaching tunnels. Merging of the leached regions 26 create a thermally stable region including the front face 22f, the chamfer 22c, and a portion of the side 22s adjacent to the chamfer.

Alternatively, a portion of the side 22s of the cutting table including the ends of the branches 11 may also be unmasked during the leaching process.

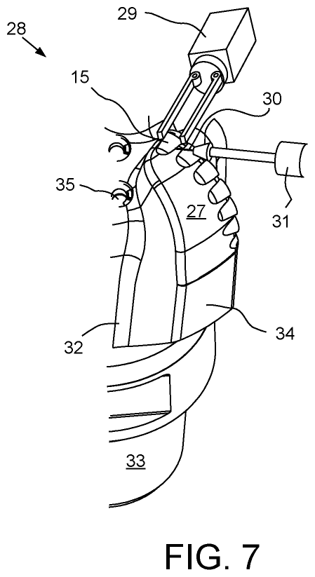

FIG. 7 illustrates brazing of the leached cutter 15 into a blade 27 of a drill bit 28. The brazing operation may be manual or automated. A plurality of the cutters 15 may be mounted into pockets formed in a leading edge of the blade 27. Each cutter 15 may be delivered to the pocket by an articulator 29. A brazing material 30 may be applied to an interface formed between the pocket and the cutter 15 using an applicator 31. As the brazing material 30 is being applied to the interface, the articulator 29 may rotate the cutter 15 relative to the pocket to distribute the brazing material 30 throughout the interface. A heater (not shown) may be operated to melt the brazing material 30. Cooling and solidification of the brazing material 30 may mount the cutter 15 to the blade 27. The brazing operation may then be repeated for mounting additional cutters into additional pockets formed along the leading edge of the blade 27. The pocket may be inclined relative to a bottom face of the blade adjacent thereto by a back-rake angle. The back rake angle may range between ten and thirty degrees.

The drill bit 28 may include a bit body 32, a shank 33, a cutting face, and a gage section 34. A lower portion of the bit body 32 adjacent to the cutting face may be made from a composite material, such as a ceramic and/or cermet body powder infiltrated by a metallic binder and an upper portion of the bit body adjacent to the shank 33 may be made from a softer material than the composite material of the upper portion, such as a metal or alloy shoulder powder infiltrated by the metallic binder. The bit body 32 may be mounted to the shank 33 during molding thereof. The shank 33 may be tubular and made from a metal or alloy, such as steel, and have a coupling, such as a threaded pin, formed at a longitudinal end thereof for connection of the drill bit 28 to a drill collar (not shown). The shank 33 may have a flow bore formed therethrough and the flow bore may extend into the bit body 32 to a plenum thereof. The cutting face may form a lower end of the drill bit 28 and the gage section 34 may form an outer portion thereof.

Alternatively, the bit body 32 may be metallic, such as being made from steel, and may be hardfaced. The metallic bit body may be connected to a modified shank by threaded couplings and then secured by a weld or the metallic bit body may be monoblock having an integral body and shank.

The cutting face may include one or more primary blades (not shown), one or more secondary blades 27, fluid courses formed between the blades, and the cutters 16. The cutting face may have one or more sections, such as an inner cone, an outer shoulder, and an intermediate nose between the cone and the shoulder sections. The blades 27 may be disposed around the cutting face and each blade may be formed during molding of the bit body 32 and may protrude from a bottom of the bit body. The primary blades and the secondary blades 27 may be arranged about the cutting face in an alternating fashion. The primary blades may each extend from a center of the cutting face, across (the rest of) the cone and nose sections, along the shoulder section, and to the gage section 34. The secondary blades 27 may each extend from a periphery of the cone section, across the nose section, along the shoulder section, and to the gage section 34. Each blade 27 may extend generally radially across the cone (primary only) and nose sections with a slight spiral curvature and along the shoulder section generally longitudinally with a slight helical curvature. Each blade 27 may be made from the same material as the bit body 32. The cutters 15 may be mounted along leading edges of the blades 27.

One or more ports 35 may be formed in the bit body 32 and each port may extend from the plenum and through the bottom of the bit body to discharge drilling fluid (not shown) along the fluid courses. Once the cutters 15 have been mounted to the respective blades 27, a nozzle (not shown) may be inserted into each port 35 and mounted to the bit body 32, such as by screwing the nozzle therein.

The gage section 34 may define a gage diameter of the drill bit 28. The gage section 34 may include a plurality of gage pads, such as one gage pad for each blade 27 and junk slots formed between the gage pads. The junk slots may be in fluid communication with the fluid courses formed between the blades 27. The gage pads may be disposed around the gage section 34 and each pad may be formed during molding of the bit body 32 and may protrude from the outer portion of the bit body. Each gage pad may be made from the same material as the bit body 32 and each gage pad may be formed integrally with a respective blade 27. Each gage pad may extend upward from a shoulder portion of the respective blade 27 to an exposed outer surface of the shank 33.

In use (not shown), the drill bit 28 may be assembled with one or more drill collars, such as by threaded couplings, thereby forming a bottomhole assembly (BHA). The BHA may be connected to a bottom of a pipe string, such as drill pipe or coiled tubing, thereby forming a drill string. The BHA may further include a steering tool, such as a bent sub or rotary steering tool, for drilling a deviated portion of the wellbore. The pipe string may be used to deploy the BHA into the wellbore. The drill bit 28 may be rotated, such as by rotation of the drill string from a rig (not shown) and/or by a drilling motor (not shown) of the BHA, while drilling fluid, such as mud, may be pumped down the drill string. A portion of the weight of the drill string may be set on the drill bit 28. The drilling fluid may be discharged by the nozzles and carry cuttings up an annulus formed between the drill string and the wellbore and/or between the drill string and a casing string and/or liner string.

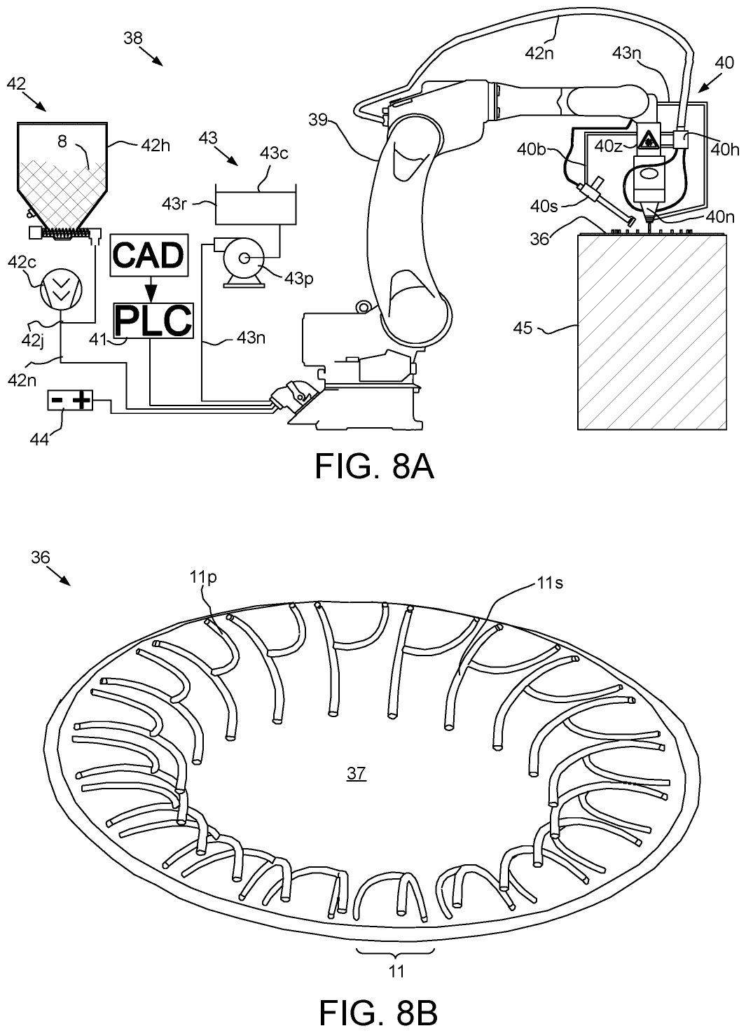

FIG. 8A illustrates additive manufacturing of a second leaching frame 36, according to another embodiment of the present disclosure. FIG. 8B illustrates the manufactured second frame 36. The second leaching frame 36 may be similar to the (first) leaching frame 1 except for having a base disk 37 instead of the base ring 10. The second leaching frame 36 may be formed using a direct metal deposition (DMD) system 38 to from the branches 11 on the prefabricated base disk 37. The DMD system 38 may include a robot 39, a deposition head 40, a programmable logic controller (PLC) 41, a material supply system 42, a cooling system 43, an electrical power supply 44, and a pedestal 45.

The robot 39 may include a base, one or more arms, and an actuator (not shown) for each arm. The base may mount the robot 39 to a floor of a manufacturing facility (not shown). A first arm of the robot 39 may be supported from the base and may be rotated relative to the base by a first actuator. The robot 39 may include one or more additional arms pivotally connected to the first arm and articulated relative thereto by one or more actuators. The deposition head 40 may be fastened to an end of the robot 39 distal from the base.

The deposition head 40 may include a laser 40z, a nozzle 40n, and a feedback sensor 40s, such as a pyrometer. An upper end of the laser 40z may be fastened to the distal end of the robot 39. An upper end of the nozzle 40n may be fastened to a lower end of the laser 40z. A bracket 40b may be fastened to an outer surface of the laser 40z and the feedback sensor 40s may be fastened to the bracket adjacent to a lower end of the nozzle 40n.

Alternatively, the deposition head 40 may include an electron beam generator instead of a laser. Alternatively, a welding head may be used instead of the deposition head 40 and a rod feeding system may be used instead of the material supply system 42.

The material supply system 42 may include a compressor 42c, a metering hopper 42h, a delivery flowline 42n, and a transport junction 42j. The metering hopper 42h may be loaded with the frame powder 8. A discharge of the metering hopper 42h and a discharge of the compressor 42c may each be connected to a respective inlet of the transport junction 42j. A discharge of the transport junction 42j may be connected to the delivery flowline 42n. The delivery flowline 42n may enter the robot 39 at the base and the robot may have one or more fluid swivels to accommodate routing of the flowline therethrough. The delivery flowline 42n may exit the fabrication robot 39 at one of the additional arms and lead to a header 40h supported from an outer surface of the laser 40z. A plurality of feed lines may extend from the header 40h to respective ports of the nozzle 40n for delivery of the frame powder 8 toward the focal point of the laser 40z.

The cooling system 43 may include a reservoir 43r of coolant 43c, such as water, a pump 43p, and a delivery line 43n. An intake of the pump 43p may be connected to the reservoir 43r and the delivery flowline 43n may be connected to a discharge of the pump. The delivery flowline 43n may enter the robot 39 at the base and the fabrication robot may have one or more fluid swivels to accommodate routing of the flowline therethrough. The delivery flowline 43n may exit the fabrication robot 2 at the end of at one of the additional arms and lead to the nozzle 3n for application of the coolant thereto.

The electrical power supply 44 may be in electrical communication with the laser 40z and the arm actuators of the robot 39 via a power cable (only one shown) extending through the respective robot. The feedback sensor 40s and arm actuators may be in electrical communication with the controller 41 via a respective data cable (only one shown) extending through the robot 39.

In operation, the second leaching frame 36 may be designed on a computer aided design (CAD) system to generate a CAD design model. The CAD design model may be converted to a computer aided manufacturing (CAM) format and supplied to the controller 41. The base disk 37 may be mounted to the pedestal 45. The controller 41 may then operate the robot 39 to begin deposition of a first slice of the branches 11. Heat generated by the laser 40z may melt the frame powder 8 (or metal portion thereof, if a metal carbide) as the robot 39 moves the deposition head 40 along the pedestal 45, thereby depositing a layer of molten material thereon. The robot 39 may repeat deposition of slices until the second leaching frame 36 has been formed.

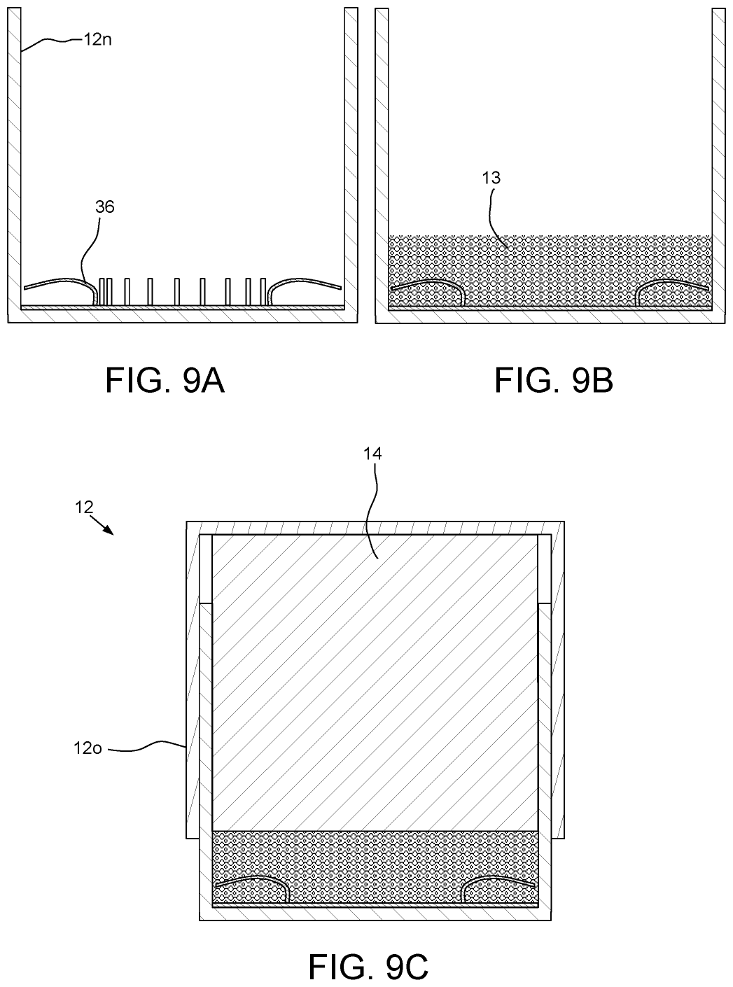

FIG. 9A illustrates the second leaching frame 36 loaded into the inner can for the high pressure and high temperature (HPHT) sintering operation. The second leaching frame 36 may be loaded into the inner can 12n so that the base disk 37 rests on a bottom thereof.

FIG. 9B illustrates cutting table powder 13 loaded into the inner can 12n. A quantity of the cutting table powder 13 may be poured into the inner can 12n. During or after pouring of the cutting table powder 13, the inner can 12n may be vibrated to compact the cutting table powder. The quantity of cutting table powder 13 may be sufficient to form a layer in the inner can 12n having a thickness sufficient to embed the second leaching frame 36 therein.

FIG. 9C illustrates the substrate 14 loaded into the inner can 12n and placement of the outer can 12o. The substrate 14 may be inserted into the cavity of the inner can 12n and into engagement with the cutting table powder 13 while a back portion of the substrate may protrude from an end of the inner can 12n. The outer can 12o may then placed over the inner can 12n. The loaded cans 12n,o may then be sealed, thereby forming a can assembly 12.

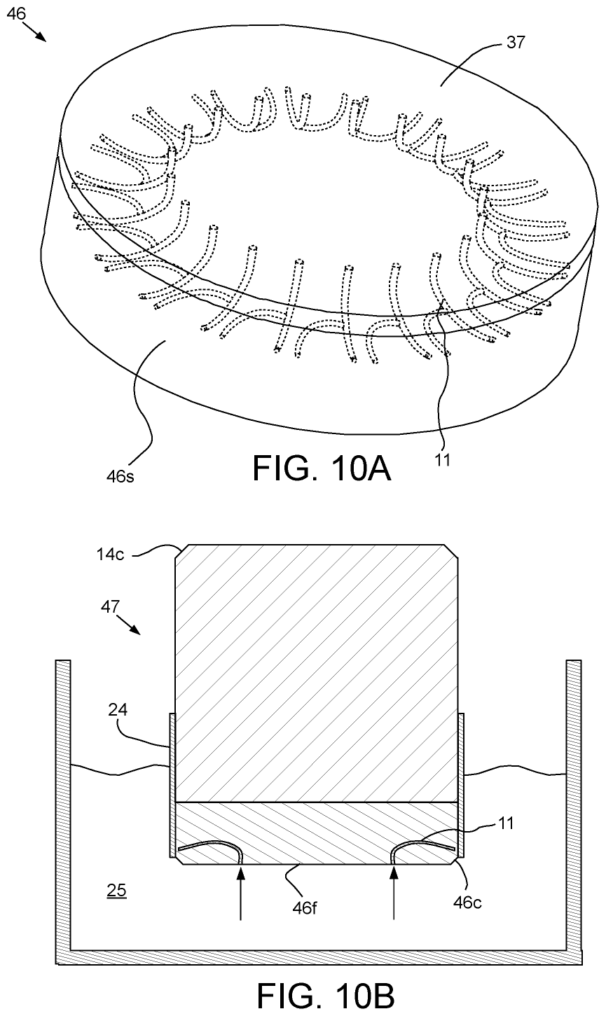

FIG. 10A illustrates the sintered cutting table 46 of a second superhard cutter 47 (FIG. 10B). A plurality of the can assemblies 12 may be assembled with the liner 16, the heating element 17, a pair of the plugs 18, and the cylinder 19 to form the cell 20. The cell 20 may then be inserted into the belt press 21, and the belt press operated to perform the HPHT sintering operation, thereby causing the metal component of the substrate 14 to melt and sweep into the cutting table powder 13. The molten metal may act as a catalyst for recrystallization of the superhard monocrystalline diamond into polycrystalline diamond (PCD), thereby forming the coherent cutting table 46, while bonding the cutting table and substrate 14 together to form the second superhard cutter 47.

The second cutter 47 may be removed from the cell 20 and inserted into the cylindrical grinder 23 and/or other finishing machines to remove excess material, polish surfaces thereof, and form a chamfer 46c into a periphery of the cutting table 46 at a front face 46f thereof distal from the substrate 14 and the chamfer 14c into a periphery of the substrate 14 at the back end thereof. During the finishing process, the base disk 37 may be ground off of the second cutter 47.

The base disk 37 may have a diameter corresponding to the diameter of the second cutting table 46. The branches 11 may extend backward and outward from the base disk 37 such that distal ends thereof are located adjacent to a side 46s of the second cutting table and behind the chamfer 46c. The distal ends of the branches 11 may be slightly sub-flush with the side 46s of the cutting table 46.

Alternatively, the distal ends of the branches 11 may be flush with the periphery of the cutting table 46.

FIG. 10B illustrates leaching of the second cutting table 46. A portion of the substrate 14 and the side 46s of the second cutting table 46 may be masked 24. At least a front portion of the cutting table 46 may then be submerged into the bath of acid 25 and left therein for a soaking time. The acid 25 may dissolve the branches 11 of the second leaching frame 36, thereby forming leaching tunnels into the second cutting table 46 along the branches. Facilitated by the leaching tunnels, the acid 25 may leach at least a substantial portion of the catalyst from a portion of the second cutting table 46 adjacent to the front face 46f and side 46s thereof. The acid 25 will also migrate through interstitial spaces in the second cutting table 46 to create additional leached regions which will merge with the leached regions attributable to the leaching tunnels. Merging of the leached regions create a thermally stable region including the front face 46f, the chamfer 46c, and a portion of the side 46s adjacent to the chamfer. A plurality of the second cutters 47 may be mounted into pockets formed in the leading edge of the blades 27 instead of the cutters 15.

Alternatively, a portion of the side 46s of the second cutting table 46 including the ends of the branches 11 may also be unmasked during the leaching process.

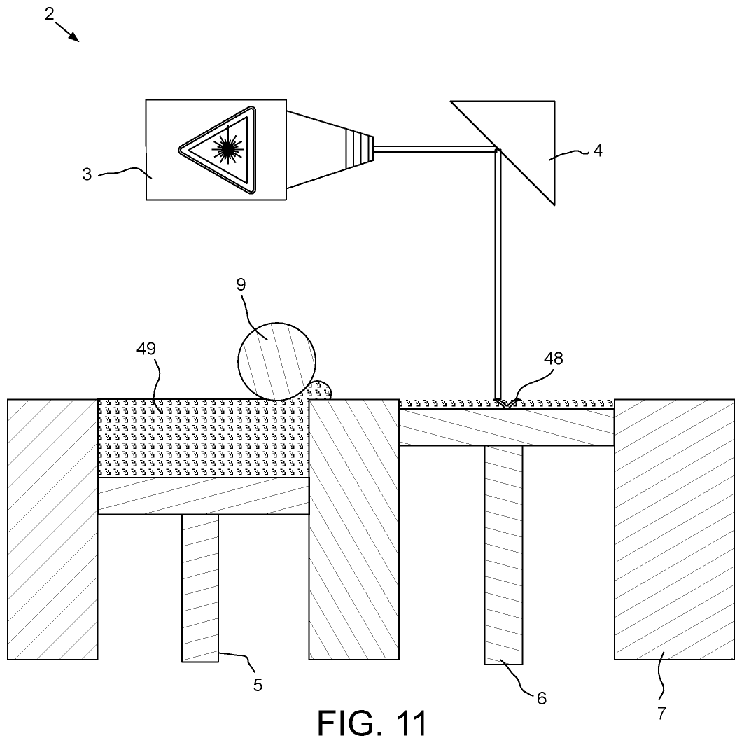

FIG. 11 illustrates additive manufacturing of a catalyst frame 48, according to one embodiment of the present disclosure. The catalyst frame 48 may be formed using the 3d printer 2 except that instead of the frame powder 2, the 3d printer may be loaded with second frame powder 49. The second frame powder 49 may be a catalyst for superhard material. For example, for diamond, the catalyst may be selected from a Group 8-10 metal or an alloy thereof, such as cobalt.

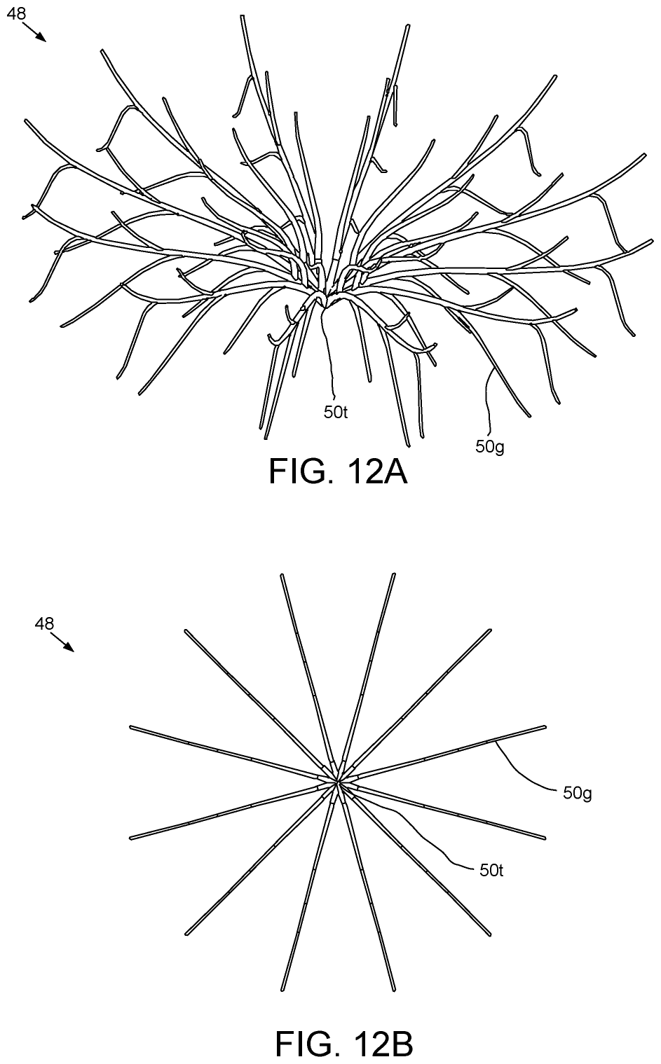

FIGS. 12A and 12B illustrate the manufactured catalyst frame 48. The catalyst frame 48 may resemble a spider in shape having a central trunk 50t and a plurality of curved legs 50g extending radially and vertically of the trunk. The catalyst frame may further have a plurality of prongs extending radially and/or vertically from each leg 50g.

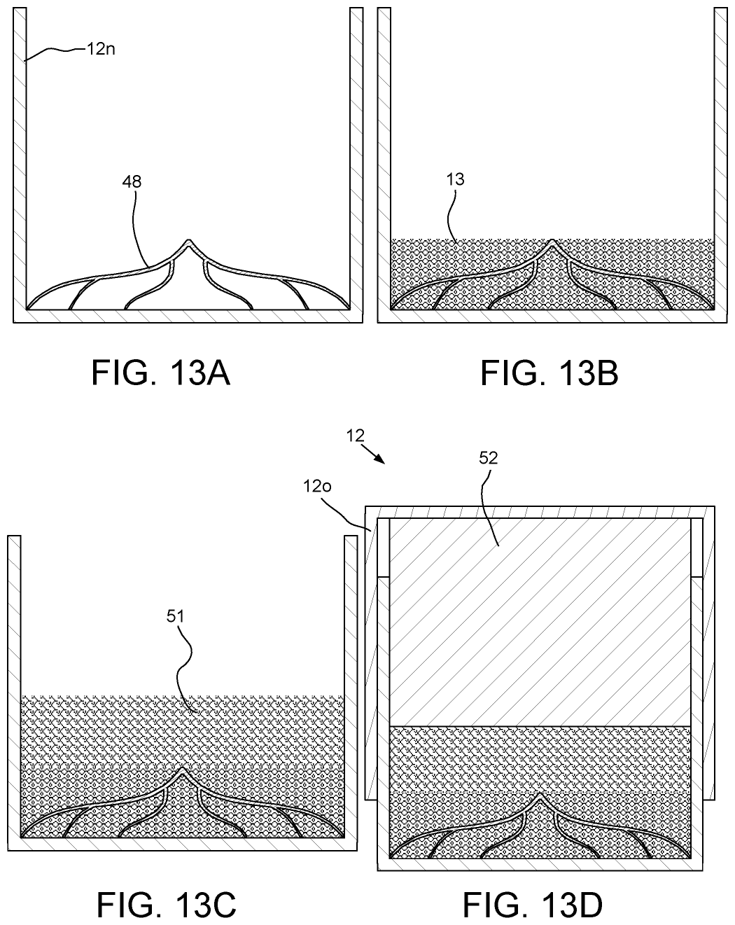

FIG. 13A illustrates the catalyst frame 48 loaded into the inner can 12n for the high pressure and high temperature (HPHT) sintering operation. The catalyst frame 48 may be loaded into the inner can 12n so that ends of the legs 50g distal from the trunk 50t rest on a bottom thereof.

FIG. 13B illustrates cutting table powder 13 loaded into the inner can 12n. A quantity of the cutting table powder 13 may be poured into the inner can 12n. During or after pouring of the cutting table powder 13, the inner can 12n may be vibrated to compact the cutting table powder. The quantity of cutting table powder 13 may be sufficient to form a layer in the inner can 12n having a thickness sufficient to embed the catalyst frame 48 frame therein.

FIG. 13C illustrates intermediate powder 51 loaded into the inner can 12n. The intermediate powder 51 may be a composite mixture of superhard material, such as monocrystalline diamond, and a ceramic. The ceramic may be the same ceramic as the ceramic member of the substrate 14, discussed above, such as tungsten carbide. The diamond may be synthetic. The composite mixture may include more superhard material than ceramic, such as greater than fifty percent by volume of superhard material, to ensure formation of polycrystalline superhard material during HPHT sintering. The amount of superhard material may range between seventy and ninety-five percent by volume. A quantity of the intermediate powder 51 may be poured into the cavity of the inner can 12n onto the cutting table powder 13. During or after pouring of the intermediate powder 51, the inner can 12n may be vibrated to compact the intermediate powder.

Alternatively, the intermediate powder 51 may include a cermet instead of or in addition to the ceramic.

FIG. 13D illustrates a second substrate 52 loaded into the inner can 12n and placement of the outer can 12o. The second substrate 52 may be similar to the substrate 14 except for having a reduced thickness to accommodate the additional intermediate powder 51. The second substrate 52 may be inserted into the cavity of the inner can 12n and into engagement with the intermediate powder 51 while a back portion of the substrate may protrude from an end of the inner can 12n. The outer can 12o may then placed over the inner can 12n. The loaded cans 12n,o may then be sealed, thereby forming a can assembly 12.

A plurality of the can assemblies 12 may be assembled with the liner 16, the heating element 17, a pair of the plugs 18, and the cylinder 19 to form the cell 20. The cell 20 may then be inserted into the belt press 21, and the belt press operated to perform the HPHT sintering operation, thereby causing the metal component of the second substrate 52 to melt and sweep into the intermediate powder 51 and the catalyst frame 48 to melt and disperse within the cutting table powder 13. The molten metal may act as a catalyst for recrystallization of the monocrystalline diamond of the cutting table powder 13 and the intermediate powder 51 and the into polycrystalline diamond (PCD), thereby forming a coherent third cutting table (not shown) from the cutting table powder and an intermediate disk from the intermediate powder 51, while bonding the third cutting table, intermediate disk, and second substrate 52 together to form a third superhard cutter (not shown). The quantity of intermediate powder 51 used may form a sufficiently thick layer in the inner can 12n to prevent the catalyst from the second substrate 52 from sweeping into the cutting table powder 13.

The third cutter may be removed from the cell 20 and inserted into the cylindrical grinder 23 and/or other finishing machines to remove excess material, polish surfaces thereof, and form a chamfer into a periphery of the cutting table at a front face thereof distal from the second substrate 52 and a chamfer into a periphery of the substrate at the back end thereof. A plurality of the third cutters may be mounted into pockets formed in the leading edge of the blades 27 instead of the cutters 15.

Advantageously, using the catalyst frame 48 to form the third cutter instead of relying on sweeping of the catalyst from the second substrate 52 may ensure that only the amount of catalyst that is sufficient to promote recrystallization of the cutting table powder 13 is used, thereby reducing or even eliminating the requirement of leaching the cutting table to impart thermal stability thereto.

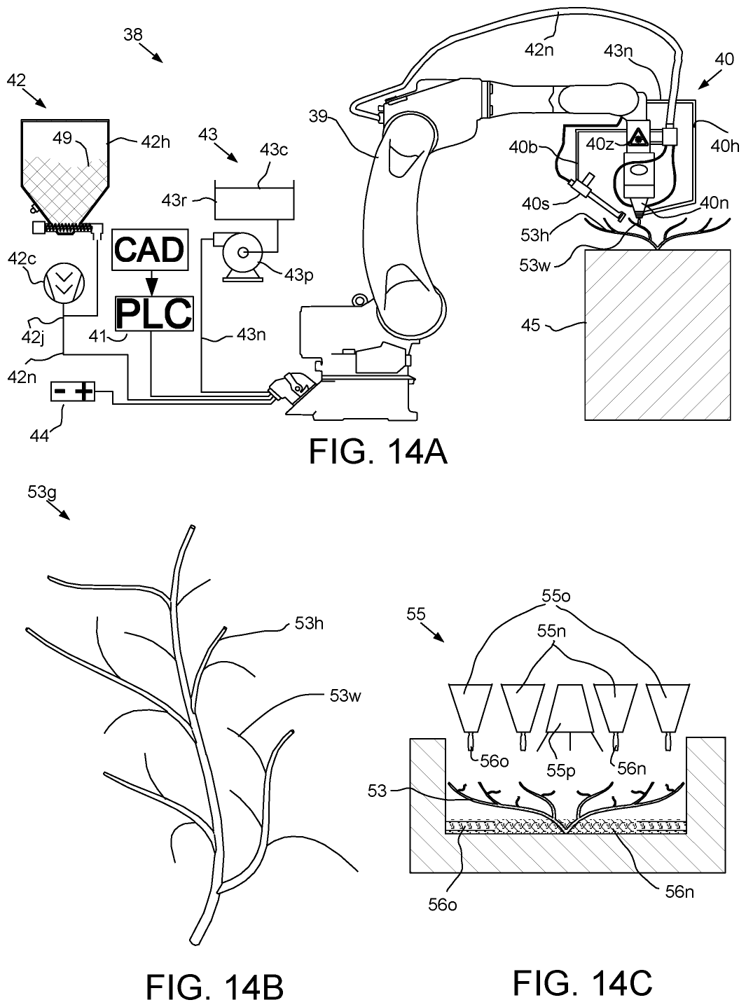

FIG. 14A illustrates additive manufacturing of a composite leaching and catalyst frame 53, according to another embodiment of the present disclosure. FIG. 14B illustrates a leg 53g of the composite frame. The composite frame 53 may include a leach portion 53h and a catalyst portion. The leach portion 53h may be similar in shape to the catalyst frame 48 and may be made using the 3d printer 2 but may be made from the frame powder 8 instead of the second frame powder 49. Once the leach portion 53h has been made using the 3d printer 2, the leach portion 53h may be mounted to the pedestal 45 of the DMD system 38. The DMD system 38, with the metering hopper 42h loaded with second frame powder 49, may then be operated to add the catalyst portion as whiskers 53w onto the prongs of the legs 53g and onto the legs themselves.

FIG. 14C illustrates additive manufacturing of a green cutting table 54g. Once the composite frame 53 has been formed, the frame may be removed from the pedestal 45 and placed into a die of a second 3d printer 55. The second 3d printer 55 may include a deposition head having a first set of one or more nozzles 55o and a second set of one or more nozzles 55n, a curing lamp 55p a slurry delivery system (not shown), a controller (not shown), a positioner (not shown), and the die. The first set of nozzles 55o may be located at an outer portion of the deposition head and the second set of nozzles 55n may be located at an inner portion of the deposition head.

The slurry delivery system may provide a supply of a first slurry 56o to the first set of nozzles 55o and a second slurry 56n to the second set of nozzles 55n. Each slurry 56n,o may include superhard, such as diamond powder, a resin, and a hardener. The diamond powder of each slurry 56n,o may be monocrystalline and synthetic. The diamond powder of the first slurry 56o may have a first particle size and the diamond powder of the second slurry 56n may have a second particle size different from the first particle size. The first particle size may be less than the second particle size to provide increased abrasion resistance for the outer portion of the fourth cutting table (not shown) and increased toughness for the inner portion of the cutting table. The second 3d printer 55 may be operated to apply the slurries 56n,o to the die via the respective nozzles 56n,o. Once the slurries 56n,o have been applied to a slice of the green cutting table 54g, the curing lamp 55p, such as an ultraviolet light (UV), may be activated to cure the slurry. This process may be repeated until the slurries 56n,o have been applied to all of the slices, thereby forming a green cutting table 54g having the composite frame 53 embedded in the polymer binder formed from the resin and the hardener.

As shown, the composite frame 53 has been placed into the die with the trunk proximate to a bottom of the die. Alternatively, the composite frame 53 may be placed into the die with the branches proximate to the bottom thereof and the die may have a nonplanar bottom for forming a shaped cutting head instead of the planar cutting head, such as the green cutting table 54g.

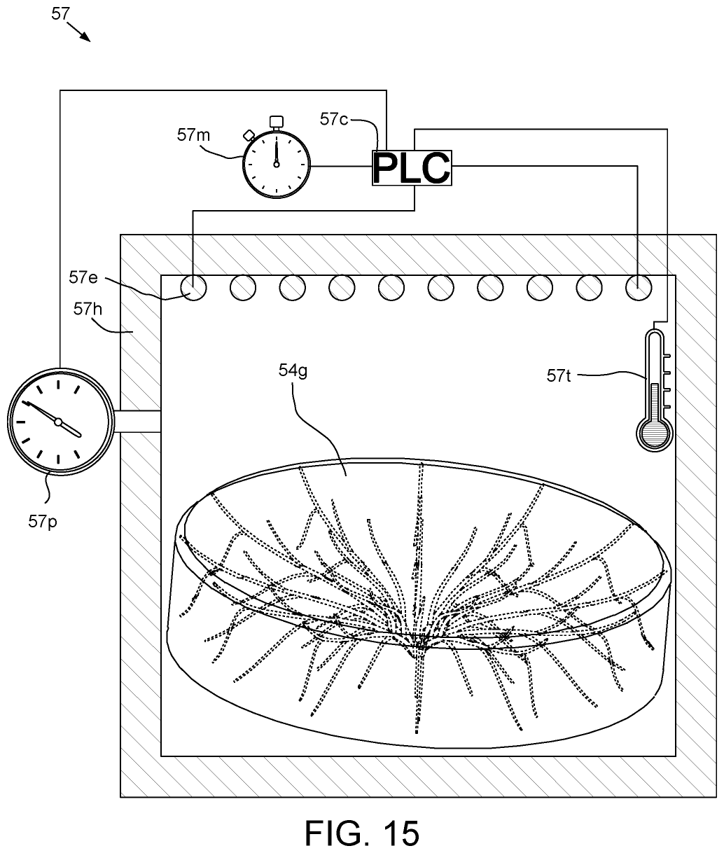

FIG. 15 illustrates de-binding of the green cutting table 54g. The green cutting table 54g may be removed from the second 3d printer 55 and placed into a furnace 57. The furnace 57 may include a housing 57h, a heating element 57e, a controller, such as programmable logic controller (PLC) 57c, a temperature sensor 57t, and a power supply (not shown). The furnace 57 may be preheated to a de-binding temperature. The green cutting table 54g may be inserted into the furnace 57 and kept therein for a de-binding time 57m to vaporize the binder. Once the binder has vaporized, the temperature and pressure in the furnace may be increased to a sintering temperature and pressure. The furnace may be pressurized to the sintering pressure 57p by injection of gas, such as an inert gas. As the green cutting table 54g is heated by the furnace 57, the whiskers 53w may melt while the leach portion 53h remains solid. During sintering, the green cutting table 54g may be consolidated into a brown cutting table 54b. The sintering pressure 57p may be insufficient to recrystallize the diamond powders.

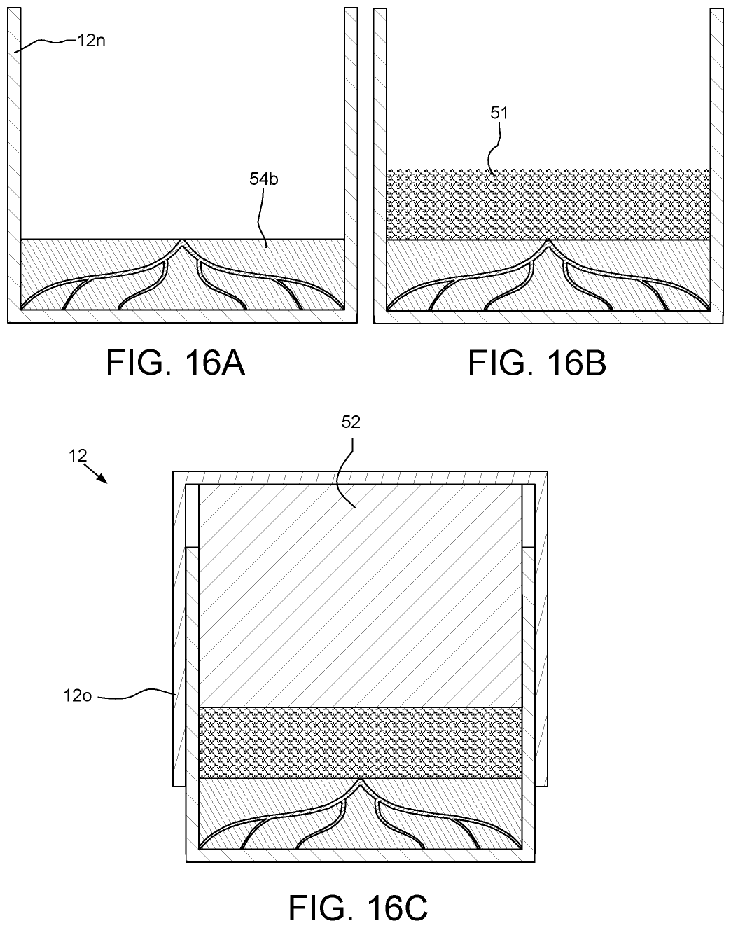

FIG. 16A illustrates the brown cutting table 54b loaded into the inner can 12n for the high pressure and high temperature (HPHT) sintering operation. The brown cutting table 54b may be loaded into the inner can 12n so that ends of the legs 53g distal from the trunk rest on a bottom thereof.

FIG. 16B illustrates the intermediate powder loaded into the inner can 12n. A quantity of the intermediate powder 51 may be poured into the cavity of the inner can 12n onto the brown cutting table 54b. During or after pouring of the intermediate powder 51, the inner can 12n may be vibrated to compact the intermediate powder.

FIG. 16C illustrates the second substrate 52 loaded into the inner can 12n and placement of the outer can 120. The second substrate 52 may be inserted into the cavity of the inner can 12n and into engagement with the intermediate powder 51 while a back portion of the substrate may protrude from an end of the inner can 12n. The outer can 12o may then placed over the inner can 12n. The loaded cans 12n,o may then be sealed, thereby forming a can assembly 12.

A plurality of the can assemblies 12 may be assembled with the liner 16, the heating element 17, a pair of the plugs 18, and the cylinder 19 to form the cell 20. The cell 20 may then be inserted into the belt press 21, and the belt press operated to perform the HPHT sintering operation, thereby causing the metal component of the second substrate 52 to melt and sweep into the intermediate powder 51 and the whiskers 53w to re-melt. The molten metal may act as a catalyst for recrystallization of the monocrystalline diamond of the inner and outer portions of the brown cutting table 54b and the intermediate powder 51 and the into polycrystalline diamond (PCD), thereby forming the fourth cutting table (not shown) from the brown cutting table 54b and an intermediate disk from the intermediate powder 51, while bonding the fourth cutting table, intermediate disk, and second substrate 52 together to form a fourth superhard cutter (not shown). The quantity of intermediate powder 51 used may form a sufficiently thick layer in the inner can 12n to prevent the catalyst from the second substrate 52 from sweeping into the brown cutting table 54b.

The fourth cutter may be removed from the cell 20 and inserted into the cylindrical grinder 23 and/or other finishing machines to remove excess material, polish surfaces thereof, and form a chamfer into a periphery of the cutting table at a front face thereof distal from the second substrate 52 and a chamfer into a periphery of the substrate at the back end thereof. The fourth cutter may then be leached in a similar fashion to the first 15 and second 47 cutters. A plurality of the fourth cutters may be mounted into pockets formed in the leading edge of the blades 27 instead of the cutters 15.

Alternatively, the whiskers 53w may be added to either the first 1 or second 36 leaching frames to form respective modified frames. Additionally, either the first or second modified frames may be used to form the green 54g and brown 54b cutting tables instead of the composite frame 53. Alternatively, the catalyst frame 48 may be used to form the green 54g and brown 54b cutting tables instead of the composite frame 53.

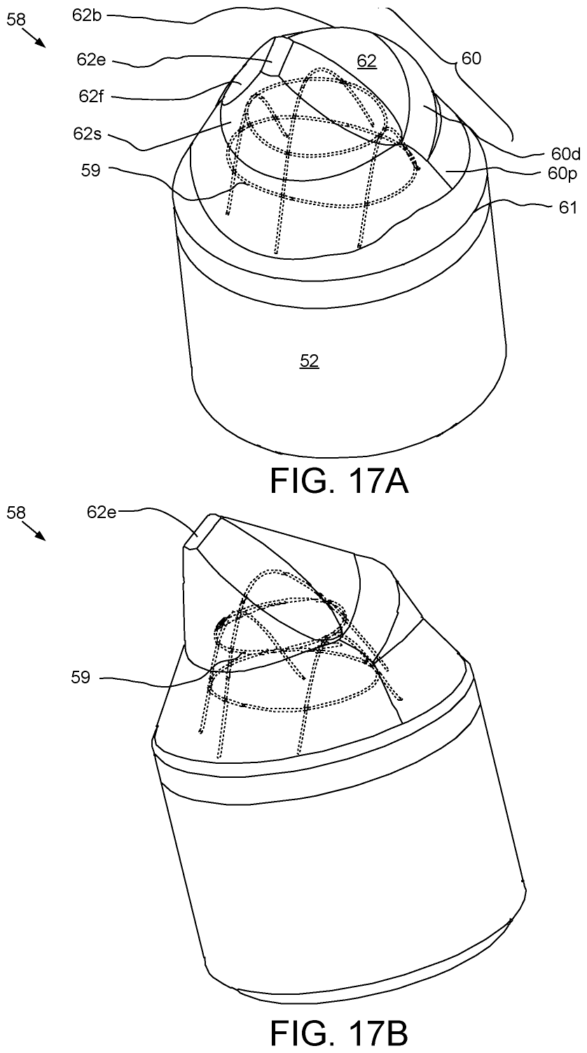

FIGS. 17A and 17B illustrate a shaped cutter 58 having a second catalyst frame 59, according to another embodiment of the present invention. The shaped cutter 58 may include the second substrate 52, the intermediate disk mounted to the second substrate, and a cutting head 60 mounted to the intermediate disk. The cutting head 60 may be made in a similar fashion as either the third or fourth cutting tables.

The cutting head 60 may have an interface 61 with the intermediate disk, a chisel 62 at an end thereof opposite to the interface, a pedestal 60p extending from the interface and connecting a side 62s of the chisel to the interface, and a dome segment 60d connecting a base 62b of the chisel to the pedestal. The pedestal 60p may have a frusto-conical portion extending from the interface 61 and an irregular portion extending from the frusto-conical portion to the dome segment 60d and to the side 62s of the chisel 62. The chisel 62 may resemble a frusto-cone with the side 62s having a truncated portion adjacent to the pedestal 60p, the base 62b having a truncated portion adjacent to the dome segment 60d, and an edge 62e formed by a pair of flats 62f formed into opposite non-truncated portions of the side. The edge 62e may be planar. The planar edge 62e may have a slight curvature. The edge 62e may have a length ranging between one percent and thirty percent of a diameter of the second substrate 52, ranging between five percent and thirty percent thereof, or ranging between ten percent and thirty percent thereof. The edge 62e may have a width ranging between one percent and sixty percent of the length thereof or ranging between ten percent and sixty percent thereof.

The chisel 62 may have an axis perpendicular to the edge 62e and the base 62b and inclined relative to a longitudinal axis of the shaped cutter 58 by an attack angle ranging between fifteen and sixty degrees. The flats 62f may be formed in the chisel 62, such as by laser cutting or electrical discharge machining, after the shaped cutter 58 has been HPHT sintered. The head 60 may have a height greater than or equal to a thickness of the second substrate 52 and less than or equal to the diameter of the second substrate. The shaped cutter 58 may be symmetrical about a longitudinal plane extending through the edge 62e.

The second catalyst frame 59 may include a pair of end arches, a middle arch, and a pair of rings connecting the arches, such as a lower ring and an upper ring. The second catalyst frame 59 is shown intact in the formed shaped cutter 58 for illustrative purpose only. In actuality, the second catalyst frame 59 would be dispersed throughout the cutting head 60 during sintering of the shaped cutter 58.

Alternatively, the flats 62f may be roughly formed during HPHT sintering and finished by laser cutting or electrical discharge machining. Alternatively, the shaped cutter 58 may have a wedge-shaped edge or a sharp edge. Alternatively, second catalyst frame 59 may include a pair of end arches, a pair of middle arches, and a pair of rings connecting the arches, such as a lower ring and an upper ring. The pair of middle arches may be separate arches or share common ends. Alternatively, one of the leaching frames 1, 36 or the composite frame 53 may be used to manufacture the shaped cutter 58.

The priority provisional application U.S. 62/753,364, filed on Oct. 31, 2018, is herein incorporated by reference in its entirety.

While the foregoing is directed to embodiments of the present disclosure, other and further embodiments of the disclosure may be devised without departing from the basic scope thereof, and the scope of the invention is determined by the claims that follow.

1. A method for manufacturing a cutter, comprising:
placing a can into a press, the can comprising superhard powder, a leaching frame embedded in the superhard powder, and catalyst;
operating the press to sinter the superhard powder, thereby forming a polycrystalline superhard cutting head; and
exposing at least a portion of the polycrystalline superhard cutting head and the frame to acid for removing at least a portion of the catalyst from the polycrystalline superhard cutting head,
wherein:
the leaching frame comprises a plurality of branches,
each branch has an inner end located adjacent to a front face of the cutting head and an outer end located adjacent to a side of the cutting head, and
the acid tunnels into the polycrystalline superhard cutting head by dissolving the leaching frame.

2. The method of claim 1, further comprising:
forming the leaching frame;
loading the leaching frame into the can; and
loading superhard powder into the can.

3. The method of claim 1, further comprising grinding a base disk of the leaching frame from the polycrystalline superhard cutting head.

4. The method of claim 1, further comprising forming the leaching frame using an additive manufacturing system.

5. The method of claim 1, wherein the cutting head is a cutting table.

6. The method of claim 1, further comprising forming a chamfer in a periphery of the cutting head at the front face, wherein the outer end of each branch is behind the chamfer.

7. The method of claim 1, wherein:
the can comprises catalyst by loading a substrate into the can, and
the substrate is bonded to the polycrystalline superhard cutting table while operating the press.

8. A method for manufacturing a cutter, comprising:
forming a leaching frame;
applying catalyst to the leaching frame, thereby forming a composite frame;
placing a can into a press, the can comprising superhard powder and the composite frame embedded in the superhard powder;
operating the press to sinter the superhard powder, thereby forming polycrystalline superhard cutting head, wherein the catalyst portion of the frame melts and disperses within the superhard powder; and
exposing at least a portion of the polycrystalline superhard cutting head and the remaining leaching frame to acid for removing at least a portion of the catalyst from the polycrystalline superhard cutting head,
wherein the acid tunnels into the polycrystalline superhard cutting head by dissolving the remaining leaching frame.

9. The method of claim 8, further comprising applying the superhard powder as part of a slurry to the composite frame and curing the slurry to form a green cutting head.

10. The method of claim 9, wherein:
the superhard powder comprises a first powder having a first particle size and a second powder having a second particle size, and
the first particle size is less than the second particle size.

11. The method of claim 9, further comprising placing the green cutting head into a furnace and operating the furnace to debind the cured slurry and melt the catalyst, thereby forming a brown cutting head.

12. The method of claim 11, further comprising:
loading the brown cutting head into the can;
loading intermediate powder into the can; and
loading a substrate into the can.

13. The method of claim 12, wherein the intermediate powder is a mixture of superhard powder and ceramic or cermet powder.

14. A method for manufacturing a cutter, comprising:
placing a can into a press, the can comprising superhard powder and a catalyst frame embedded in the superhard powder; and
operating the press to sinter the superhard powder, thereby forming a polycrystalline superhard cutting head.

15. The method of claim 14, further comprising:
loading intermediate powder into the can; and
loading a substrate into the can.

16. The method of claim 15, wherein the intermediate powder is a mixture of superhard powder and ceramic or cermet powder.

17. The method of claim 14, further comprising applying the superhard powder as part of a slurry to the catalyst frame and curing the slurry to form a green cutting head.

18. The method of claim 17, wherein:
the superhard powder comprises a first powder having a first particle size and a second powder having a second particle size, and
the first particle size is less than the second particle size.

19. The method of claim 17, further comprising placing the green cutting head into a furnace and operating the furnace to debind the cured slurry and melt the catalyst frame, thereby forming a brown cutting head.

20. The method of claim 19, further comprising:
loading the brown cutting head into the can;
loading intermediate powder into the can; and
loading a substrate into the can.
